(19) United States
(12) Patent Application Publication
(10) Pub. No.: US 2026/0030837 A1
(43) Pub. Date: Jan. 29, 2026

(54) MACHINE LEARNING-BASED GENERATION OF THREE-DIMENSIONAL REPRESENTATIONS

(71) Applicant: Dell Products L.P., Round Rock, TX (US)

(72) Inventors: Zijia Wang, London (GB); Junyi Wu, Shanghai (CN); Tianlu Fei, Shanghai (CN); Bin He, Shanghai (CN); Zhenzhen Lin, Shanghai (CN); Zhen Jia, Shanghai (CN)

(21) Appl. No.: 18/780,747

(22) Filed: Jul. 23, 2024

(51) Int. Cl. G06T 17/00; G06N 20/00

(52) U.S. Cl. CPC G06T 17/00; G06N 20/00; G06T 2207/10028

(57) ABSTRACT

An apparatus comprises at least one processing device configured to extract a set of features from a user prompt using a natural language processing model, to initialize a three-dimensional scene reconstruction model utilizing a set of parameters determined based at least in part on the set of features extracted from the user prompt, and to generate, utilizing the three-dimensional scene reconstruction model, a set of two-dimensional images of a given scene from two or more different viewpoint perspectives. The at least one processing device is also configured to apply an image diffusion model to the generated set of two-dimensional images to generate a refined set of two-dimensional images, to modify the three-dimensional scene reconstruction model based at least in part on the refined set of two-dimensional images, and to utilize the modified three-dimensional scene reconstruction model to generate a three-dimensional representation of the given scene.

### BACKGROUND

As the value and use of information continues to increase, individuals and businesses seek additional ways to process and store information. Information processing systems may be used to process, compile, store and communicate various types of information. Because technology and information processing needs and requirements vary between different users or applications, information processing systems may also vary (e.g., in what information is processed, how the information is processed, how much information is processed, stored, or communicated, how quickly and efficiently the information may be processed, stored, or communicated, etc.). Information processing systems may be configured as general purpose, or as special purpose configured for one or more specific users or use cases (e.g., financial transaction processing, airline reservations, enterprise data storage, global communications, etc.). Information processing systems may include a variety of hardware and software components that may be configured to process, store, and communicate information and may include one or more computer systems, data storage systems, and networking systems.

### SUMMARY

Illustrative embodiments of the present disclosure provide techniques for machine learning-based generation of three-dimensional representations.

In one embodiment, an apparatus comprises at least one processing device comprising a processor coupled to a memory. The at least one processing device is configured to extract a set of features from a user prompt using a natural language processing model, to initialize a three-dimensional scene reconstruction model utilizing a set of parameters determined based at least in part on the set of features extracted from the user prompt, and to generate, utilizing the three-dimensional scene reconstruction model, a set of two-dimensional images of a given scene from two or more different viewpoint perspectives. The at least one processing device is also configured to apply an image diffusion model to the generated set of two-dimensional images to generate a refined set of two-dimensional images, to modify the three-dimensional scene reconstruction model based at least in part on the refined set of two-dimensional images, and to utilize the modified three-dimensional scene reconstruction model to generate a three-dimensional representation of the given scene.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based generation of three-dimensional representations in an illustrative embodiment.

FIG. 2 is a flow diagram of an exemplary process for machine learning-based generation of three-dimensional representations in an illustrative embodiment.

FIG. 3 shows a system flow for user prompt-driven three-dimensional model generation in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

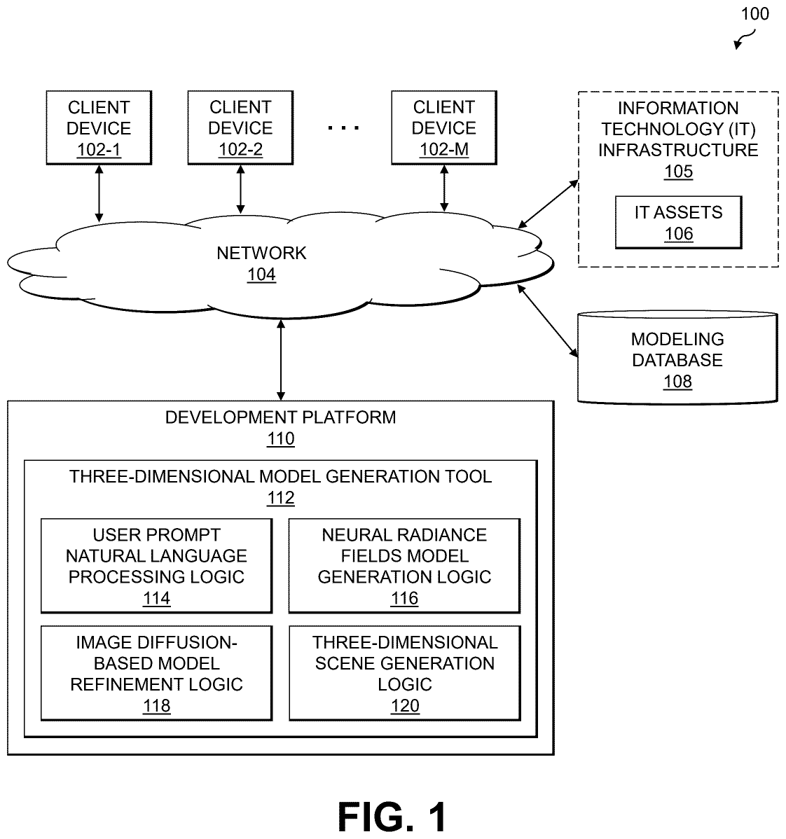

FIG. 1 shows an information processing system 100 configured in accordance with an illustrative embodiment. The information processing system 100 is assumed to be built on at least one processing platform and provides functionality for machine learning-based generation of three-dimensional (3D) representations. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a modeling database 108, and a development platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the development platform 110 is used for an enterprise system. For example, an enterprise may subscribe to or otherwise utilize the development platform 110 for generation of three-dimensional (3D) models for use in digital content creation (e.g., in product development, marketing and sales, customization and personalization, training and simulation, enterprise solutions, etc.) for an enterprise, organization or other entity. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The modeling database 108 is configured to store and record various information that is utilized by the development platform 110. Such information may include, for example, user prompts (e.g., text-based, voice or audio-based using speech-to-text conversion, etc.), model parameters for Neural Radiance Fields (NeRF) and image diffusion models, generated three-dimensional (3D) scenes, etc. The modeling database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the development platform 110, as well as to support communication between the development platform 110 and other related systems and devices not explicitly shown.

The development platform 110 may be provided as a cloud service that is accessible by one or more of the client devices 102 to allow users thereof to manage generation of 3D scene representations based on input user prompts for different users of an enterprise, organization or other entity. In some embodiments, the client devices 102 are assumed to be associated with users of an enterprise, organization or other entity that seeks to generate and utilize 3D scene models. In some embodiments, the client devices 102 are utilized by members of the same enterprise, organization or other entity that operates the development platform 110. In other embodiments, the client devices 102 are utilized by members of one or more enterprises, organizations or other entities different than the enterprise, organization or other entity that operates the development platform 110 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the modeling database 108 and the development platform 110 regarding user prompt-driven generation of 3D models. It should be noted that a “host agent” as this term is generally used herein may comprise an automated entity, such as a software entity running on a processing device. Accordingly, a host agent need not be a human entity.

The development platform 110 in the FIG. 1 embodiment is assumed to be implemented using at least one processing device. Each such processing device generally comprises at least one processor and an associated memory, and implements one or more functional modules or logic for controlling certain features of the development platform 110. In the FIG. 1 embodiment, the development platform 110 implements a 3D model generation tool 112. The 3D model generation tool 112 comprises user prompt natural language processing (NLP) logic 114, NeRF model generation logic 116, image diffusion-based model refinement logic 118, and 3D scene generation logic 120. The user prompt NLP logic 114 is configured to extract a set of features from a user prompt using an NLP model. The user prompt may comprise, for example, a text prompt, a speech or audio-based prompt (which may be converted to text using a speech-to-text conversion model), etc. The NeRF model generation logic 116 is configured to initialize an NeRF model (e.g., an example of a machine learning 3D scene reconstruction model) utilizing a set of parameters determined based at least in part on the set of features extracted from the user prompt. The NeRF model is used to generate a set of 2D images of a given scene from two or more different viewpoint perspectives. The image diffusion-based model refinement logic 118 is configured to apply an image diffusion model to the generated set of 2D images to generate a refined set of 2D images, and to modify the NeRF model based at least in part on the refined set of 2D images. The 3D scene generation logic 120 is configured to utilize the modified NeRF model to generate a 3D representation of the given scene.

At least portions of the 3D model generation tool 112, the user prompt NLP logic 114, the NeRF model generation logic 116, the image diffusion-based model refinement logic 118, and the 3D scene generation logic 120 may be implemented at least in part in the form of software that is stored in memory and executed by a processor.

It is to be appreciated that the particular arrangement of the client devices 102, the IT infrastructure 105, the modeling database 108 and the development platform 110 illustrated in the FIG. 1 embodiment is presented by way of example only, and alternative arrangements can be used in other embodiments. As discussed above, for example, the development platform 110 (or portions of components thereof, such as one or more of the 3D model generation tool 112, the user prompt NLP logic 114, the NeRF model generation logic 116, the image diffusion-based model refinement logic 118, and the 3D scene generation logic 120) may in some embodiments be implemented internal to the IT infrastructure 105.

The development platform 110 and other portions of the information processing system 100, as will be described in further detail below, may be part of cloud infrastructure.

The development platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the modeling database 108 and the development platform 110 or components thereof (e.g., the 3D model generation tool 112, the user prompt NLP logic 114, the NeRF model generation logic 116, the image diffusion-based model refinement logic 118, and the 3D scene generation logic 120) may be implemented on respective distinct processing platforms, although numerous other arrangements are possible. For example, in some embodiments at least portions of the development platform 110 and one or more of the client devices 102, the IT infrastructure 105, the IT assets 106 and/or the modeling database 108 are implemented on the same processing platform. A given client device (e.g., 102-1) can therefore be implemented at least in part within at least one processing platform that implements at least a portion of the development platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the modeling database 108 and the development platform 110, or portions or components thereof, to reside in different data centers. Numerous other distributed implementations are possible. The development platform 110 can also be implemented in a distributed manner across multiple data centers.

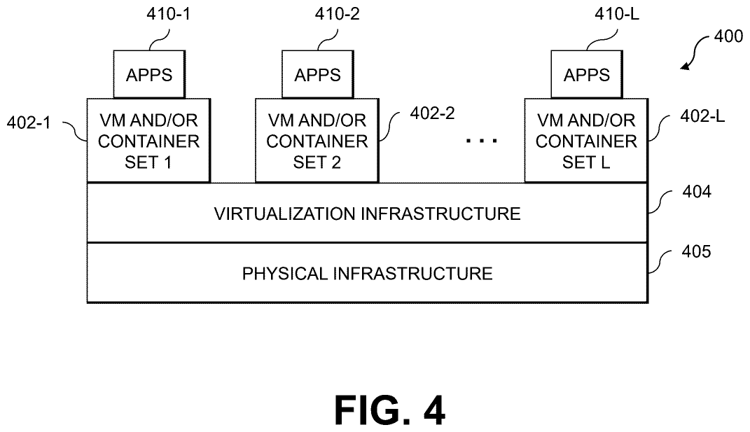

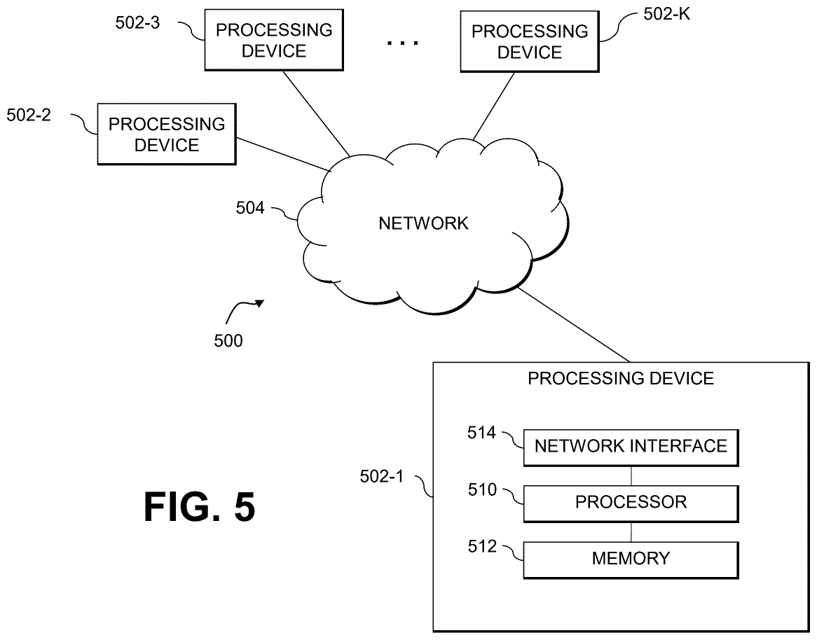

Additional examples of processing platforms utilized to implement the development platform 110 and other components of the information processing system 100 in illustrative embodiments will be described in more detail below in conjunction with FIGS. 4 and 5.

It is to be understood that the particular set of elements shown in FIG. 1 for machine learning-based generation of 3D representations is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

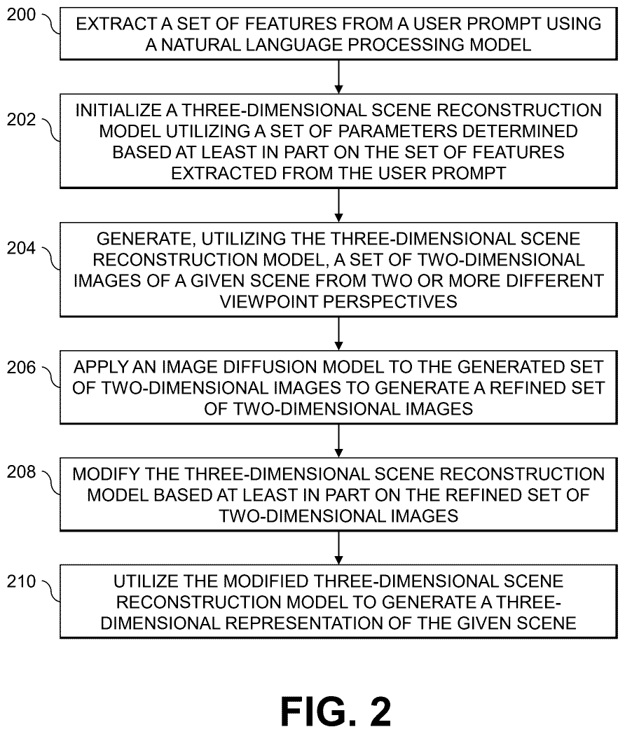

An exemplary process for machine learning-based generation of 3D representations will now be described in more detail with reference to the flow diagram of FIG. 2. It is to be understood that this particular process is only an example, and that additional or alternative processes for machine learning-based generation of 3D representations may be used in other embodiments.

In this embodiment, the process includes steps 200 through 210. These steps are assumed) to be performed by the development platform 110 utilizing the 3D model generation tool 112, the user prompt NLP logic 114, the NeRF model generation logic 116, the image diffusion-based model refinement logic 118, and the 3D scene generation logic 120. The process begins with step 200, extracting a set of features from a user prompt using an NLP model. In step 202, a 3D scene reconstruction model is initialized using a set of parameters determined based at least in part on the set of features extracted from the user prompt. The 3D scene reconstruction model may comprise an NeRF model configured to take as input a 3D position vector and a 2D viewing direction and output a color and density at each of two or more points of the given scene. Step 202 may include initializing weights of a neural network that represents a neural radiance field.

In step 204, a set of 2D images of a given scene from two or more different viewpoint perspectives is generated utilizing the 3D scene reconstruction model. Step 204 may comprise selecting the two or more different viewpoint perspectives to capture a range of perspectives of the given scene, for each of the two or more different viewpoint perspectives, performing ray tracing through the given scene for a plurality of rays, where a color and density of each of the plurality of rays is computed using the three-dimensional scene reconstruction model, and synthesizing the set of 2D images of the given scene using the plurality of rays.

An image diffusion model is applied to the generated set of 2D images to generate a refined set of 2D images in step 206. The image diffusion model may comprise a denoising diffusion probabilistic model (DDPM). Applying the image diffusion model to the generated set of 2D images may comprise applying a noise-reduction process to the generated set of 2D images by: inputting the generated set of 2D images to the image diffusion model, predicting noise added at each timestep based at least in part on an output of the image diffusion model, and removing the predicted noise from the generated set of two-dimensional images to generate the refined set of two-dimensional images.

The 3D scene reconstruction model is modified in step 208 based at least in part on the refined set of 2D images. Step 208 may comprise estimating probability densities for pixels of the refined set of 2D images, and adjusting the set of parameters of the 3D scene reconstruction model based at least in part on the estimated probability densities. Estimating the probability densities for the pixels of the refined set of 2D images utilizes a density estimation model that takes the refined set of 2D images and the user prompt as input and computes probability density likelihoods of the pixels of the refined set of 2D images. Adjusting the set of parameters of the 3D scene reconstruction model may also or alternatively comprise utilizing a gradient descent algorithm that utilizes a loss function comprising a negative log-likelihood of the estimated probability densities for the pixels of the refined set of 2D images.

In step 210, the modified 3D scene reconstruction model is utilized to generate a 3D representation of the given scene. In some embodiments, the user prompt comprises a natural language description of a design of a product, and step 210 comprises generating a 3D representation of a prototype of the product. In other embodiments, the user prompt comprises a natural language description of a virtual showroom of one or more products, and step 210 comprises generating a 3D representation of the one or more products for the virtual showroom. In other embodiments, the user prompt comprises a natural language description specifying one or more customizations of a product, and step 210 comprises generating a 3D representation of a customized version of the product based at least in part on the specified one or more customizations. In other embodiments, the user prompt comprises a natural language description of one or more features of a product, and step 210 comprises generating a 3D representation of a training simulation for the one or more features of the product. In other embodiments, the user prompt comprises a natural language description of a configuration of an IT infrastructure environment, and step 210 comprises generating a 3D representation of the configuration of the IT infrastructure environment.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

In recent years, the demand for automated and accurate three-dimensional (3D) model generation from textual descriptions has significantly increased, including in industries such as gaming, virtual reality (VR), augmented reality (AR), and digital content creation. Conventional approaches often rely on manual modeling or less interactive generative models, which can be time-consuming, lack flexibility, and struggle with accurately translating textual descriptions into detailed 3D representations. Illustrative embodiments provide technical solutions which address these and other technical challenges through integration of advanced machine learning techniques in 3D model generation. In some embodiments, Neural Radiance Fields (NeRF) are combined with two-dimensional (2D) image diffusion models to generate and refine 3D models directly from textual descriptions.

Advantageously, the integration of NeRF and 2D image diffusion models provides a unique combination that leverages the strengths of both NeRF and 2D image diffusion for accurate 3D scene generation. Further, the technical solutions allow for user prompt-driven model initialization and refinement through the ability to initiate and refine 3D models based on natural language inputs, enhancing the creative and interactive aspects of 3D modeling. The technical solutions also enable advanced rendering and optimization, including employing advanced rendering from multiple viewpoints and the use of optimization techniques for consistent and high-quality 3D model generation. The technical solutions may be utilized in various use cases and industries, including but not limited to VR, AR, 3D animation, and digital content creation, offering a new dimension in user interaction and content generation. The technical solutions thus provide significant advancements in 3D modeling, providing a highly efficient, flexible and user-friendly approach to transforming textual descriptions into vivid 3D representations.

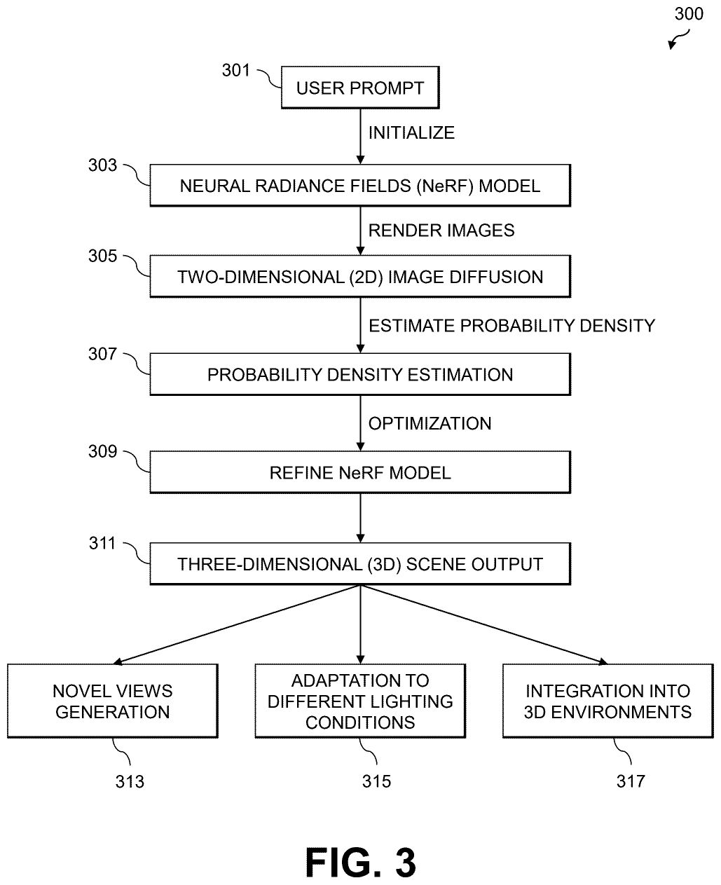

FIG. 3 shows a system flow 300 for user prompt-driven 3D model generation. The system flow 300 begins in block 301 with interpreting a user prompt (e.g., “a red car with a spoiler”), which is used to initialize a NeRF model in block 303. The NeRF model is configured to represent a 3D scene as a function of location and viewing direction. The NeRF model renders 2D images from various viewpoints, which are then processed in block 305 for 2D image diffusion. Block 305 may include processing the 2D images through a diffusion model that estimates the pixel probability density in line with the user prompt, resulting in probability density estimation in block 307. A unique loss function based on probability density distillation evaluates the NeRF model's alignment with the textual description, ensuring smoothness and viewpoint consistency. In block 309, the NeRF model undergoes iterative refinement (e.g., through gradient descent optimization), leading to a final version of the NeRF model that accurately embodies the described 3D scene. The refined NeRF model is used to generate a final 3D scene output in block 311. The refined NeRF model and the final 3D scene output may be further utilized for novel views generation in block 313, adaptation to different lighting conditions in block 315, and integration into 3D environments in block 317.

The technical challenges of generating 3D models from textual descriptions may be analyzed from various perspectives, including shape synthesis, scene composition, and image-based rendering.

Shape synthesis from text aims to create 3D models of objects that match the semantic and geometric information given by natural language descriptions. This task is challenging, because it requires understanding the meaning and structure of the text, as well as generating realistic and detailed shapes that satisfy the constraints imposed by the text. In some approaches, a shape grammar framework is used to parse text descriptions into hierarchical shape structures and then synthesize 3D models using a database of shape parts. Such approaches, however, are limited by the predefined shape grammar and the availability of shape parts, and are unable to handle complex or novel descriptions.

In other approaches, deep learning models are used to learn to map text descriptions to 3D shapes, either directly or through intermediate representations. For example, a recurrent neural network (RNN) may be used to encode text descriptions into latent vectors, and then decode them into 3D voxel grids using a convolutional neural network (CNN). An attention mechanism and a conditional variational autoencoder (CVAE) may be used to improve the text encoding and shape diversity. A shape deformation module may also be used to refine the initial shape generated by the CVAE using a graph neural network (GNN) and a differentiable renderer. Such approaches, however, are restricted by the low resolution and discretization artifacts of voxel representations, and cannot capture fine-grained details or view-dependent effects.

The technical solutions described herein overcome these and other technical challenges at least in part through utilization of NeRF as the underlying representation for 3D scenes, which can model continuous and high-resolution shapes with view-dependent appearance. Further, the technical solutions utilize image diffusion models for generating and refining 2D images from multiple viewpoints, which are then used to optimize the NeRF model using a probability density distillation loss. This allows for leveraging the large-scale and diverse image data that is available, and avoids the need for explicit 3D supervision. The technical solutions are also able to use natural language user prompts as the sole input for initializing and refining the NeRF model, without relying on any shape priors or parts databases. This enables the technical solutions to handle open-vocabulary and complex descriptions, and to generate novel and diverse 3D models.

The technical solutions described herein are able to address various technical challenges associated with generating 3D models from textual descriptions, including technical challenges related to high-resolution and continuous shape representation, view-dependent effects, the lack of large-scale and diverse 3D supervision, handling complex and open-vocabulary descriptions, and integration of multiple modalities. Conventional approaches often struggle with creating high-resolution 3D shapes that are continuous and lack discretization artifacts. This challenge is especially prominent in voxel-based representations, which are limited in resolution and detail. Capturing view-dependent effects such as lighting, shading and texture details, which are crucial for realistic rendering of 3D models, is often not feasible with conventional shape synthesis approaches. Conventional approaches also typically rely heavily on a limited set of 3D shape databases or predefined shape grammars, which restricts the diversity and novelty of the generated models. The ability to interpret and accurately render 3D models from complex, open-vocabulary textual descriptions remains a significant technical challenge, and requires advanced understanding of natural language semantics and structure. In addition, effectively combining information from different modalities (e.g., text and 2D images) to enhance the accuracy and quality of generated 3D models presents technical challenges. The technical solutions described herein address these and other technical challenges at least in part through combining NeRF with 2D image diffusion models, leveraging the strengths of both to generate highly detailed, view-dependent, and diverse 3D models from textual descriptions.

The system flow 300 of FIG. 3 shows an implementation of the technical solutions described herein which enables generation of 3D models from textual descriptions using a combination of NeRF and 2D image diffusion models. The system flow 300 begins with the interpretation of a user prompt in block 301, leading to initialization of a NeRF model in block 303. The NeRF model is then used to render 2D images from various viewpoints, which are processed through a diffusion model in block 305 that refines them based on the user prompt. In block 307, probability density estimation is performed to estimate probability density, which is then used for optimization of the NeRF model to produce a refined NeRF model in block 309 (e.g., using a probability density distillation loss), which results in a detailed and accurate 3D scene output in block 311.

NeRF model initialization in block 303 will now be described in further detail. The goal of the NeRF model initialization is to create an initial 3D representation that loosely aligns with the textual description of the user prompt interpreted in block 301. The user prompt is analyzed using a natural language processing (NLP) model in block 301 to extract key features and descriptors. Such features are then used for initial parameter setting to initialize the NeRF model in block 303. This includes initializing the weights of the neural network that represents the radiance field. The equation for initial parameter setting is:

$${Θ}_{0} = {f}_{init} ( NLP ( prompt ) )$$

where Θ₀ represents the initial parameters of the NeRF model, ƒᵢₙᵢₜ is the initialization function, and NLP(prompt) is the output from the NLP model. The NeRF model architecture may include a fully connected deep neural network, which takes as input a 3D position x=(x, y, z) and 2D viewing direction d=(θ, ϕ). The network outputs the color c and density σ at each point. The NeRF input and output is thus:

$$NeRF ( x ; d ; Θ ) \to ( c , σ )$$

where x is the input 3D position, d is the viewing direction, Θ represents the model parameters, c is the output color, and σ is the density.

2D image rendering will now be described in further detail. Once the NeRF model is initialized in block 303, it is utilized to render 2D images from various viewpoints. These 2D images provide the data needed for the subsequent diffusion process. The rendering process includes viewpoint selection and ray tracing. Viewpoint selection may include selection of random viewpoints to capture a wide range of perspectives of the 3D scene. Ray tracing includes, for each viewpoint, tracing rays through the scene and using the NeRF model to compute the color and density of each ray. For a ray R(t)=o+td, where o is the origin and d is the direction, the color C(R) is computed as:

$$C ( R ) = {\int }_{{t}_{n}}^{{t}_{f}} T ( t ) σ ( R ( t ) ) c ( R ( t ) , d ) dt$$

where

$$T ( t ) = exp ( - {\int }_{{t}_{n}}^{t} σ ( R ( s ) ) ds )$$

is the accumulated transmittance, σ is the density, and c is the color output by the NeRF model. Image synthesis includes accumulating each ray's contribution to synthesize the final image from that viewpoint. This process is repeated for each selected viewpoint, generating a set of 2D images.

Image diffusion processing in block 305 will now be described in further detail. The image diffusion process involves refining the initially rendered 2D images from the NeRF model to better align with the textual description. In some embodiments, this is achieved through a denoising diffusion probabilistic model (DDPM). The DDPM iteratively applies a noise-reduction process to the rendered images. This process may be modeled according to:

$${x}_{t - 1} = \sqrt{{α}_{t} - 1} ( \frac{{x}_{t} - \sqrt{1 - {α}_{t}} {ϵ}_{θ} ( {x}_{t} , t )}{\sqrt{{α}_{t}}} ) + \sqrt{1 - {α}_{t - 1}} {ϵ}_{t}$$

where xₜ is the image at timestep t, αₜ is the variance schedule, and ϵ_{θ} is the noise prediction model. The refinement process includes inputting the rendered images to the DDPM, using the DDPM to predict the noise added at each timestep, and removing the noise. This process is repeated iteratively, enhancing the image quality and alignment with the user prompt to make the images ready for further processing in the next stage of the pipeline. The output of this stage is a set of refined 2D images. The next step is to estimate the probability density (e.g., of each pixel) in block 307.

Probability density estimation in block 307 will now be described in further detail. After refining the images through the diffusion process, the probability density of each pixel is estimated. This estimation is useful for aligning the NeRF model with the textual description. In some embodiments, the model used for density estimation takes the refined images and user prompt as input, and computes the likelihood of each pixel. The likelihood function may be described as:

$$p ( x \vert prompt ) = {\prod }_{i = 1}^{N} p ( {x}_{i} \vert prompt )$$

where x represents the pixels in the refined image, and N is the number of pixels. The probability density is used to determine how well the pixels of the refined images align with the user prompt. A higher probability indicates a better alignment, guiding the optimization of the NeRF model in block 309.

The NeRF model refinement and optimization in block 309 will now be described in further detail. The optimization of the NeRF model is based on maximizing the probability density estimated in block 307, ensuring that the final 3D model closely matches the textual description. In some embodiments, this is achieved through gradient descent, adjusting the NeRF parameters to increase the overall probability density. The optimization of the NeRF model ensures that the final 3D representation accurately reflects the textual description. This process includes adjusting the parameters of the NeRF model based on the probability density estimates obtained from the refined 2D images.

In some embodiments, the objective of the optimization process is to maximize the alignment of the NeRF-generated images with the user prompt. This may be quantified through the probability density estimates. The optimization function can be formulated as:

$${Θ}^{*} {=}_{Θ} {\sum }_{i = 1}^{N} log p ( {x}_{i} \vert prompt ; Θ )$$

where Θ* are the optimized parameters, Θ are the initial parameters, xᵢ are the pixels of the refined images, and N is the number of pixels. The parameters of the NeRF model may be updated using gradient descent, leveraging the backpropagation of the error between the estimated probability densities and the actual densities:

$${Θ}_{new} = {Θ}_{old} - η \cdot {∇}_{Θ} ℒ ( Θ )$$

where η is the learning rate, and [symbol] (Θ) is the loss function defined as the negative log-likelihood of the estimated probabilities.

After refinement of the NeRF model in block 309, the refined NeRF model represents the final 3D scene output in block 311. The refined NeRF model is capable of generating images from any viewpoint, with the scene accurately reflecting the features described in the user prompt.

The technical solutions described herein provide various technical advantages in the domain of 3D model generation and refinement using text-based prompts. The integration of NeRF and image diffusion models provides a unique combination and integration which leverages the high-resolution and continuous nature of NeRF with the generative capabilities of diffusion models, offering unprecedented detail and realism in generated 3D models from textual descriptions. Further, user prompt-driven 3D scene generation uses natural language prompts to directly initialize and refine 3D scenes, allowing for a highly intuitive and user-friendly interface for 3D model generation, accommodating a wide range of descriptions from simple to complex. The technical solutions further employ advanced rendering and refinement techniques, enabling generation of 2D images from multiple viewpoints of the NeRF model, followed by a novel refinement process using image diffusion models. This not only enhances the fidelity of the 3D models, but also ensures consistency and coherence across different views. The use of probability density-based optimization for optimizing the NeRF model provides further technical advantages. This approach ensures that the final 3D model is not only visually accurate, but also statistically aligned with the textual prompt, leading to more representative and realistic models. These various technical advantages enable the technical solutions to provide a groundbreaking approach in the realm of 3D modeling, offering a solution that is not only technologically advanced but also highly accessible and user-centric.

The technical solutions provide functionality for generating and refining 3D models from textual descriptions, leveraging synergy between NeRF and 2D image diffusion models. The integration of NeRF with 2D image diffusion models allows for the creation of highly detailed and realistic 3D scenes directly from textual prompts. Further, the use of advanced rendering and refinement techniques ensures that the generated models are not only visually appealing but also consistent and coherent across different views. The implementation of probability density-based optimization aligns the final 3D model closely with the input text, thereby enhancing the accuracy and representativeness of the final 3D model. The technical solutions provide an end-to-end pipeline for 3D model generation which is user-friendly, efficient and versatile, making it suitable for a wide range of applications across various industries. The technical solutions can thus be leveraged for creative and practical applications in areas such as VR, AR, 3D animation, and digital content creation The technical solutions thus provide powerful tools for artists, designers and developers, enabling them to bring textual descriptions to life in a more intuitive and efficient way. The technical solutions not only advance technological capabilities in 3D model generation, but also enhance the accessibility and usability of such technologies, making the creation of 3D content from text a reality.

Illustrative, non-limiting example use cases of the technical solutions will now be described in further detail. Such uses cases include product development, marketing and sales, customization and personalization, training and simulation, and enterprise solutions.

For product development, the technical solutions described herein can transform the way that products (e.g., computing devices or other types of IT assets) are designed and prototyped. By using 3D model generation capabilities, designers can rapidly visualize and iterate on new product concepts in 3D, significantly speeding up the prototype phase and reducing costs associated with physical prototyping.

For marketing and sales, the integration of realistic 3D models generated from textual descriptions can enhance online and digital marketing strategies. By incorporating these models into digital campaigns and virtual showrooms, an enterprise, organization or other entity can offer customers or other users a more interactive and detailed view of products, potentially increasing engagement and sales.

For customization and personalization, leveraging user prompt-driven 3D scene generation allows for a high degree of product customization, which can provide a unique selling point for an enterprise, organization or other entity as customers or other users thereof could visualize and tailor products to their specifications online before purchase, enhancing customer satisfaction and loyalty.

For training and simulation, advanced rendering and refinement techniques can be used to create realistic training simulations for both internal staff and customer or other user education. This can improve the understanding of complex product features and capabilities, leading to better customer service and more effective use of an enterprise, organization or other entity's products.

For enterprise solutions, in enterprise environments the probability density-based optimization techniques can be utilized to create detailed and scalable 3D models (e.g., of data center setups or other IT infrastructure environments), aiding in planning and visualization of complex solutions.

By implementing the technical solutions described herein in these and other use cases, an enterprise, organization or other entity can enhance its product development and customer or other user interaction while also strengthening market leadership through advanced digital capabilities.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based generation of 3D representations will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100 in FIG. 1. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. A hypervisor platform may be used to implement a hypervisor within the virtualization infrastructure 404, where the hypervisor platform has an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based generation of 3D representations as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to extract a set of features from a user prompt using a natural language processing model;
to initialize a three-dimensional scene reconstruction model utilizing a set of parameters determined based at least in part on the set of features extracted from the user prompt;
to generate, utilizing the three-dimensional scene reconstruction model, a set of two-dimensional images of a given scene from two or more different viewpoint perspectives;
to apply an image diffusion model to the generated set of two-dimensional images to generate a refined set of two-dimensional images;
to modify the three-dimensional scene reconstruction model based at least in part on the refined set of two-dimensional images; and
to utilize the modified three-dimensional scene reconstruction model to generate a three-dimensional representation of the given scene.

2. The apparatus of claim 1 wherein the three-dimensional scene reconstruction model comprises a Neural Radiance Field (NeRF) model configured to take as input a three-dimensional position vector and a two-dimensional viewing direction and output a color and density at each of two or more points of the given scene.

3. The apparatus of claim 2 wherein initializing the three-dimensional scene reconstruction model comprises initializing weights of a neural network that represents a neural radiance field.

4. The apparatus of claim 1 wherein generating the set of two-dimensional images of the given scene from two or more different viewpoint perspectives comprises:
selecting the two or more different viewpoint perspectives to capture a range of perspectives of the given scene;
for each of the two or more different viewpoint perspectives, performing ray tracing through the given scene for a plurality of rays, where a color and density of each of the plurality of rays is computed using the three-dimensional scene reconstruction model; and
synthesizing the set of two-dimensional images of the given scene using the plurality of rays.

5. The apparatus of claim 1 wherein the image diffusion model comprises a denoising diffusion probabilistic model (DDPM).

6. The apparatus of claim 1 wherein applying the image diffusion model to the generated set of two-dimensional images comprises applying a noise-reduction process to the generated set of two-dimensional images by:
inputting the generated set of two-dimensional images to the image diffusion model;
predicting noise added at each timestep based at least in part on an output of the image diffusion model; and
removing the predicted noise from the generated set of two-dimensional images to generate the refined set of two-dimensional images.

7. The apparatus of claim 1 wherein modifying the three-dimensional scene reconstruction model based at least in part on the refined set of two-dimensional images comprises:
estimating probability densities for pixels of the refined set of two-dimensional images; and
adjusting the set of parameters of the three-dimensional scene reconstruction model based at least in part on the estimated probability densities.

8. The apparatus of claim 7 wherein estimating the probability densities for the pixels of the refined set of two-dimensional images utilizes a density estimation model that takes the refined set of two-dimensional images and the user prompt as input and computes probability density likelihoods of the pixels of the refined set of two-dimensional images.

9. The apparatus of claim 7 wherein adjusting the set of parameters of the three-dimensional scene reconstruction model comprises utilizing a gradient descent algorithm that utilizes a loss function comprising a negative log-likelihood of the estimated probability densities for the pixels of the refined set of two-dimensional images.

10. The apparatus of claim 1 wherein the user prompt comprises a natural language description of a design of a product, and wherein utilizing the modified three-dimensional scene reconstruction model to generate the three-dimensional representation of the given scene comprises generating a three-dimensional representation of a prototype of the product.

11. The apparatus of claim 1 wherein the user prompt comprises a natural language description of a virtual showroom of one or more products, and wherein utilizing the modified three-dimensional scene reconstruction model to generate the three-dimensional representation of the given scene comprises generating a three-dimensional representation of the one or more products for the virtual showroom.

12. The apparatus of claim 1 wherein the user prompt comprises a natural language description specifying one or more customizations of a product, and wherein utilizing the modified three-dimensional scene reconstruction model to generate the three-dimensional representation of the given scene comprises generating a three-dimensional representation of a customized version of the product based at least in part on the specified one or more customizations.

13. The apparatus of claim 1 wherein the user prompt comprises a natural language description of one or more features of a product, and wherein utilizing the modified three-dimensional scene reconstruction model to generate the three-dimensional representation of the given scene comprises generating a three-dimensional representation of a training simulation for the one or more features of the product.

14. The apparatus of claim 1 wherein the user prompt comprises a natural language description of a configuration of an information technology infrastructure environment, and utilizing the modified three-dimensional scene reconstruction model to generate the three-dimensional representation of the given scene comprises generating a three-dimensional representation of the configuration of the information technology infrastructure environment.

15. A computer program product comprising a non-transitory processor-readable storage medium having stored therein program code of one or more software programs, wherein the program code when executed by at least one processing device causes the at least one processing device:
to extract a set of features from a user prompt using a natural language processing model;
to initialize a three-dimensional scene reconstruction model utilizing a set of parameters determined based at least in part on the set of features extracted from the user prompt;
to generate, utilizing the three-dimensional scene reconstruction model, a set of two-dimensional images of a given scene from two or more different viewpoint perspectives;
to apply an image diffusion model to the generated set of two-dimensional images to generate a refined set of two-dimensional images;
to modify the three-dimensional scene reconstruction model based at least in part on the refined set of two-dimensional images; and
to utilize the modified three-dimensional scene reconstruction model to generate a three-dimensional representation of the given scene.

16. The computer program product of claim 15 wherein the three-dimensional scene reconstruction model comprises a Neural Radiance Field (NeRF) model configured to take as input a three-dimensional position vector and a two-dimensional viewing direction and output a color and density at each of two or more points of the given scene.

17. The computer program product of claim 15 wherein modifying the three-dimensional scene reconstruction model based at least in part on the refined set of two-dimensional images comprises:
estimating probability densities for pixels of the refined set of two-dimensional images; and
adjusting the set of parameters of the three-dimensional scene reconstruction model based at least in part on the estimated probability densities.

18. A method comprising:
extracting a set of features from a user prompt using a natural language processing model;
initializing a three-dimensional scene reconstruction model utilizing a set of parameters determined based at least in part on the set of features extracted from the user prompt;
generating, utilizing the three-dimensional scene reconstruction model, a set of two-dimensional images of a given scene from two or more different viewpoint perspectives;
applying an image diffusion model to the generated set of two-dimensional images to generate a refined set of two-dimensional images;
modifying the three-dimensional scene reconstruction model based at least in part on the refined set of two-dimensional images; and
utilizing the modified three-dimensional scene reconstruction model to generate a three-dimensional representation of the given scene;
wherein the method is performed by at least one processing device comprising a processor coupled to a memory.

19. The method of claim 18 wherein the three-dimensional scene reconstruction model comprises a Neural Radiance Field (NeRF) model configured to take as input a three-dimensional position vector and a two-dimensional viewing direction and output a color and density at each of two or more points of the given scene.

20. The method of claim 18 wherein modifying the three-dimensional scene reconstruction model based at least in part on the refined set of two-dimensional images comprises:
estimating probability densities for pixels of the refined set of two-dimensional images; and
adjusting the set of parameters of the three-dimensional scene reconstruction model based at least in part on the estimated probability densities.
